(19) United States
(12) Patent Application Publication
(10) Pub. No.: US 2008/0166607 A1
(43) Pub. Date: Jul. 10, 2008

(54) Fuel Cell System and Transporting Equipment Including the Same

(75) Inventors: Yasuyuki Muramatsu, Shizuoka (JP); Hideo Kohda, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Shizuoka-ken (JP)

(21) Appl. No.: 10/558,772

(22) PCT Filed: Oct. 25, 2004
(86) PCT No.: PCT/JP2004/016187

§ 371 Date: Mar. 14, 2008

(30) Foreign Application Priority Data
Oct. 24, 2003 (JP) 2003-365205

(51) Int. Cl. H01M 8/04

(52) U.S. Cl. 429/22

(57) ABSTRACT

A fuel cell system includes a fuel tank which stores a methanol fuel, an aqueous solution tank which stores a methanol aqueous solution having a concentration less than that of the methanol fuel, a fuel pump which supplies the methanol fuel stored in the fuel tank to the aqueous solution tank, a fuel cell stack which is supplied with the methanol aqueous solution from the aqueous solution tank for generating electric energy through electrochemical reactions, a water tank which stores water to be supplied to the aqueous solution tank, a water pump for supplying water stored in the water tank to the aqueous solution tank, a concentration sensor which detects the concentration of the methanol aqueous solution supplied to the fuel cell stack, a fluid surface detection sensor which detects a fluid surface height of the methanol aqueous solution in the aqueous solution tank, and a controller which controls a supply operation of the fuel pump and the water pump based on an output from the concentration sensor, and supply operation of the fuel pump and the water pump based on an output from the fluid surface detection sensor.

### BACKGROUND OF THE INVENTION

1. Field of the Invention

The present invention relates to a fuel cell system and transporting equipment including the fuel cell system. More specifically, the present invention relates to a direct methanol fuel cell system which uses unreformed methanol directly for power generation, and transporting equipment including such a direct methanol fuel cell system.

2. Description of the Related Art

In recent years, in the field of fuel cells which use methanol as fuel for power generation, efforts have been made to develop direct methanol fuel cells (hereinafter abbreviated as DMFC). Differing from reformed-methanol PEFC (Polymer Electrolyte Fuel Cells) in which methanol is reformed and resulting hydrogen is used as the fuel for power generation, DMFC is supplied with an aqueous solution of methanol directly in its cells for generating electric energy through electrochemical reactions with oxygen supplied from a separate route.

With no components required for reforming methanol, DMFC has a simplified construction and a reduced weight, and is expected to be used in a variety of applications.

An example of DMFC is disclosed in JP-A 2003-132924 for example. In this DMFC, carbon dioxide and water vapor resulting from the electrochemical reactions in the fuel cell are sent to a gas/liquid separation chamber, from which carbon dioxide and air are discharged to the outside whereas unused methanol and water are recycled back to the fuel tank.

Generally in DMFC, an excessively high concentration of methanol aqueous solution supplied to the fuel cell stack will cause excessive crossover in which unused methanol passes through the electrolyte in the fuel cell stack and to the cathode side, potentially resulting in a decrease in electromotive force. Further, an excessively low concentration of the methanol aqueous solution damages the solid electrolyte film due to uneven distribution of the fuel. For this reason, it is necessary to control the concentration of the methanol aqueous solution which is supplied to the cells so as to maintain a constant concentration.

In this respect, the DMFC disclosed in JP-A 2003-132924 uses a concentration sensor provided in a fuel tank for detecting the concentration in the fuel tank. The methanol concentration in the fuel tank is controlled to be a predetermined value by supplying high concentration methanol from a high concentration methanol tank in response to detected values.

The DMFC disclosed in JP-A 2003-132924 has a problem, however. Specifically, the supply of high concentration methanol from the high concentration methanol tank (which corresponds to a fuel tank in the present invention) to the fuel tank (which corresponds to an aqueous solution tank in the present invention) is made without detection of the volume of liquid in the fuel tank, and is made regardless of the internal status in the tank. This can lead to a problem that the methanol aqueous solution overflows from the fuel tank, leading to a malfunction of the fuel cell system. In addition, the concentration control of the methanol aqueous solution in the fuel tank may become ineffective if the high concentration methanol tank does not contain any high concentration methanol. These problems decrease the reliability of the fuel cell systems.

### SUMMARY OF THE INVENTION

In order to overcome the problems described above, preferred embodiments of the present invention provide a fuel cell system which includes a fuel tank for storing fuel, an aqueous solution tank for storing a fuel aqueous solution having a concentration lower than that of the fuel, a fuel supplier for supplying the fuel stored in the fuel tank to the aqueous solution tank, a fuel-cell cell-stack supplied with the fuel aqueous solution from the aqueous solution tank for generating electric energy through electrochemical reactions, a water tank for storing water to be supplied to the aqueous solution tank, a water supplier for supplying water stored in the water tank to the aqueous solution tank, a concentration detector for detecting the concentration of the fuel aqueous solution supplied to the fuel-cell cell-stack, an aqueous solution data detector for detecting data relating to an amount of the fuel aqueous solution stored in the aqueous solution tank, and a controller for controlling a supply operation of at least one of the fuel supplier and the water supplier based on output from the concentration detector, and for controlling a supply operation of the fuel supplier and the water supplier based on output from the aqueous solution data detector.

According to another preferred embodiment of the present invention, if the concentration of the fuel aqueous solution in the aqueous solution tank is greater than a predetermined value, the water supplier supplies water from the water tank to the aqueous solution tank, whereby the concentration of the fuel aqueous solution in the aqueous solution tank is decreased toward the predetermined value. On the other hand, if the concentration of the fuel aqueous solution in the aqueous solution tank is less than the predetermined value, the fuel supplier supplies fuel from the fuel tank to the aqueous solution tank, whereby the concentration of the fuel aqueous solution in the aqueous solution tank is increased toward the predetermined value. During the concentration control, the aqueous solution data detector detects data regarding the amount of fuel aqueous solution stored in the aqueous solution tank. Operation of the fuel supplier and the water supplier is controlled based on output from the aqueous solution data detector. In this manner, the concentration control of the fuel aqueous solution is performed while detecting the amount of fuel aqueous solution in the aqueous solution tank, so as to adjust the concentration to be close to the predetermined level while maintaining the amount of fuel aqueous solution at an appropriate level in the aqueous solution tank, and to provide a fuel cell system which is highly reliable.

Preferably, the controller stops the supply operation of the fuel supplier and the water supplier if an output from the aqueous solution data detector indicates that the amount of fuel aqueous solution stored in the aqueous solution tank has reached an upper limit. This stops the supply of fuel aqueous solution and water to the aqueous solution tank, and therefore prevents the fuel aqueous solution from overflowing the aqueous solution tank.

The fuel cell system preferably further includes an aqueous solution supplier for supplying the fuel aqueous solution stored in the aqueous solution tank to the fuel-cell cell-stack, and a fuel data detector for detecting data regarding the amount of fuel stored in the fuel tank. With this arrangement, the controller stops a supply operation of the fuel supplier, the aqueous solution supplier and the water supplier if an output from the fuel data detector indicates that the amount of fuel stored in the fuel tank has reached a lower limit. As a result, malfunctions in the fuel cell system are prevented from occurring. Further, the concentration of the fuel aqueous solution (fuel concentration) is prevented from becoming excessively low, and the solid electrolyte film is prevented from being damaged. Thus, the reliability of the fuel cell system is maintained at a very high level.

Further, the fuel cell system preferably includes a water data detector for detecting data regarding the amount of water stored in the water tank. With this arrangement, the controller stops a supply operation of the fuel supplier, the aqueous solution supplier and the water supplier if an output from the water data detector indicates that the amount of water stored in the water tank has reached a lower limit. As a result, an excessive increase in the concentration of the fuel aqueous solution caused by an insufficient supply of water from the water tank to the aqueous solution tank is prevented. This prevents an excessive temperature increase in the fuel-cell cell-stack, and maintains high reliability of the fuel cell system.

According to another preferred embodiment of the present invention, a fuel cell system is provided which includes a fuel tank for storing fuel, an aqueous solution tank for storing a fuel aqueous solution having a concentration lower than that of the fuel, a fuel supplier for supplying the fuel stored in the fuel tank to the aqueous solution tank, a fuel-cell cell-stack supplied with the fuel aqueous solution from the aqueous solution tank for generating electric energy through electrochemical reactions, a water tank for storing water to be supplied to the aqueous solution tank, a water supplier for supplying water stored in the water tank to the aqueous solution tank, a water data detector for detecting data regarding the amount of the water stored in the water tank, and a controller for controlling a supply operation of the fuel supplier based on output from the water data detector.

According to a preferred embodiment of the present invention, the water data detector detects data regarding the amount of water in the water tank, to control the supply of high concentration fuel from the fuel tank to the aqueous solution tank by controlling a supply operation of the fuel supplier based on output from the water data detector. This stabilizes the concentration of the fuel aqueous solution in the aqueous solution tank, and improves the reliability of the fuel cell system.

Preferably, the controller stops the supply operation of the fuel supplier if an output from the water data detector indicates that the amount of water stored in the water tank has reached a lower limit. In this case, the concentration of the fuel aqueous solution in the aqueous solution tank does not increase to an excessive level.

According to another preferred embodiment of the present invention, a fuel cell system is provided which includes a fuel tank for storing fuel, an aqueous solution tank for storing a fuel aqueous solution of a concentration lower than that of the fuel, a fuel supplier for supplying the fuel stored in the fuel tank to the aqueous solution tank, a fuel-cell cell-stack supplied with the fuel aqueous solution from the aqueous solution tank for generating electric energy through electrochemical reactions, a water tank for storing water to be supplied to the aqueous solution tank, a water supplier for supplying water stored in the water tank to the aqueous solution tank, a fuel data detector for detecting data regarding the amount of the fuel stored in the fuel tank, and a controller for controlling a supply operation of the water supplier based on output from the fuel data detector.

According to a preferred embodiment of the present invention, the fuel data detector detects data regarding the amount of fuel in the fuel tank, to control the supply of water from the water tank to the aqueous solution tank by controlling a supply operation of the water supplier based on output from the fuel data detector. As a result, the concentration of the fuel aqueous solution in the aqueous solution tank is stabilized, and the reliability of the fuel cell system is improved.

Preferably, the controller stops the supply operation of the water supplier if an output from the fuel data detector indicates that the amount of the fuel stored in the fuel tank has reached a lower limit. In this case, the concentration of the fuel aqueous solution in the aqueous solution tank does not decrease to an excessive level.

The fuel cell system according to various preferred embodiments of the present invention is suitably used in transporting equipment.

Other features, elements, steps, characteristics and advantages of the present invention will become more apparent from the following detailed description of preferred embodiments with reference to the attached figures.

### BRIEF DESCRIPTION OF THE DRAWINGS

FIG. 1 is a left-side view of a two-wheeled vehicle equipped with a direct methanol fuel cell system according to a preferred embodiment of the present invention.

FIG. 2 is a perspective view of the two-wheeled vehicle of FIG. 1, without a cover and other components.

FIG. 3 is a left-side perspective view, showing the general construction of a frame of the two-wheeled vehicle of FIG. 1 and FIG. 2 and a fuel cell system mounted on the frame.

FIG. 4 is a right-side perspective view, showing the general construction of the frame of the two-wheeled vehicle of FIG. 1 and FIG. 2 and the fuel cell system mounted on the frame.

FIG. 5 is a left-side perspective view, showing the general construction of the fuel cell system mounted on the two-wheeled vehicle of FIG. 1 through FIG. 4.

FIG. 6 is a perspective view, showing an aqueous solution tank and a fuel tank of the fuel cell system of FIG. 2 through FIG. 5, mounted on the two-wheeled vehicle.

FIG. 7 is an illustration showing a piping structure between the aqueous solution tank and a water tank in the fuel cell system of FIG. 5.

FIG. 8 is an illustration showing an enlarged view of internal connections in the water tank, in the piping structure in the fuel cell system of FIG. 7.

FIG. 9 is a sectional view of a portion, taken along arrows IX-IX in FIG. 8, showing a connection between a pipe which is connected with the water tank and a pipe extending from the aqueous solution tank.

FIG. 10 is a plan view is provided in FIG. 10(a), showing the general construction of an integrated structure of the aqueous solution tank and the fuel tank in the fuel cell system of FIG. 2 through FIG. 6. A side view is provided in FIG. 10(b), showing the aqueous solution tank and the fuel tank in FIG. 10(a) in a mounted state. FIG. 10(c) provides a sectional view taken in arrows X(c)-X(c) in FIG. 10(a).

FIG. 11 is a block diagram of the fuel cell system of FIG. 2 through FIG. 5.

FIG. 12 is a general flowchart for describing an operation example of the fuel cell system.

### DETAILED DESCRIPTION OF PREFERRED EMBODIMENTS

Hereinafter, preferred embodiments of the present invention will be described, with reference to the drawings.

A preferred embodiment in which a fuel cell system according to the present invention is mounted on a two-wheeled vehicle is described.

It is noted that the terms left and right, front and rear, up and down as used in this preferred embodiment are determined from the normal riding position, i.e. determined by the rider sitting on the rider's seat of a two-wheeled vehicle 1, with the rider facing toward the handles.

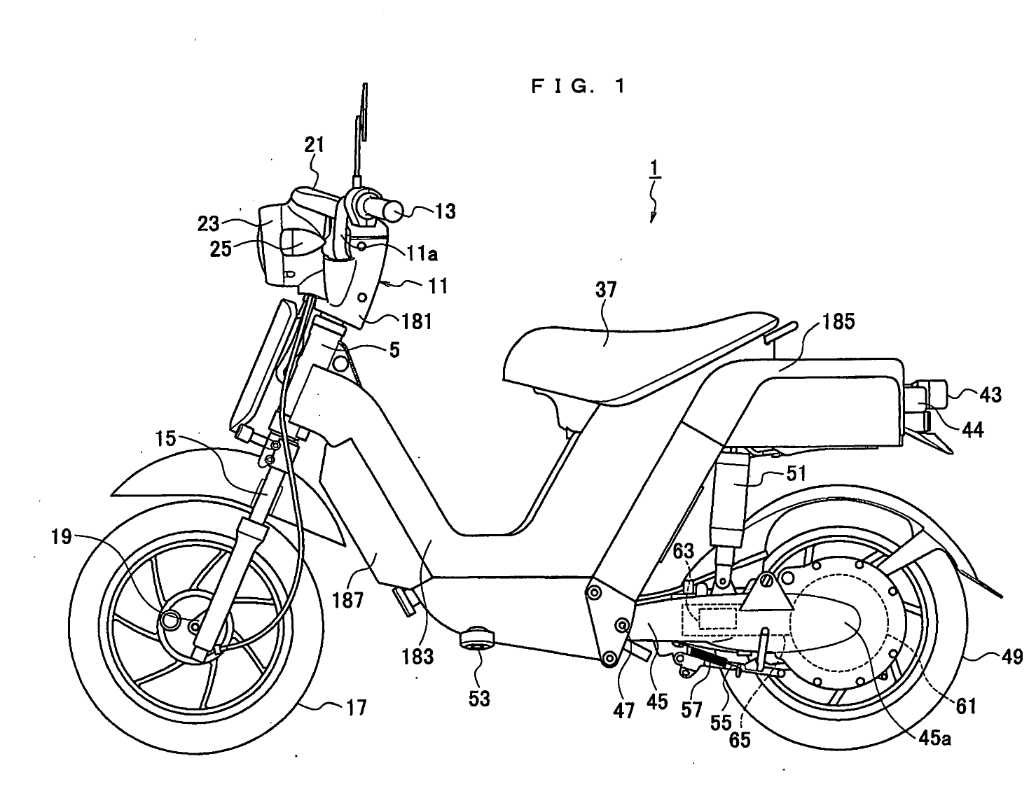

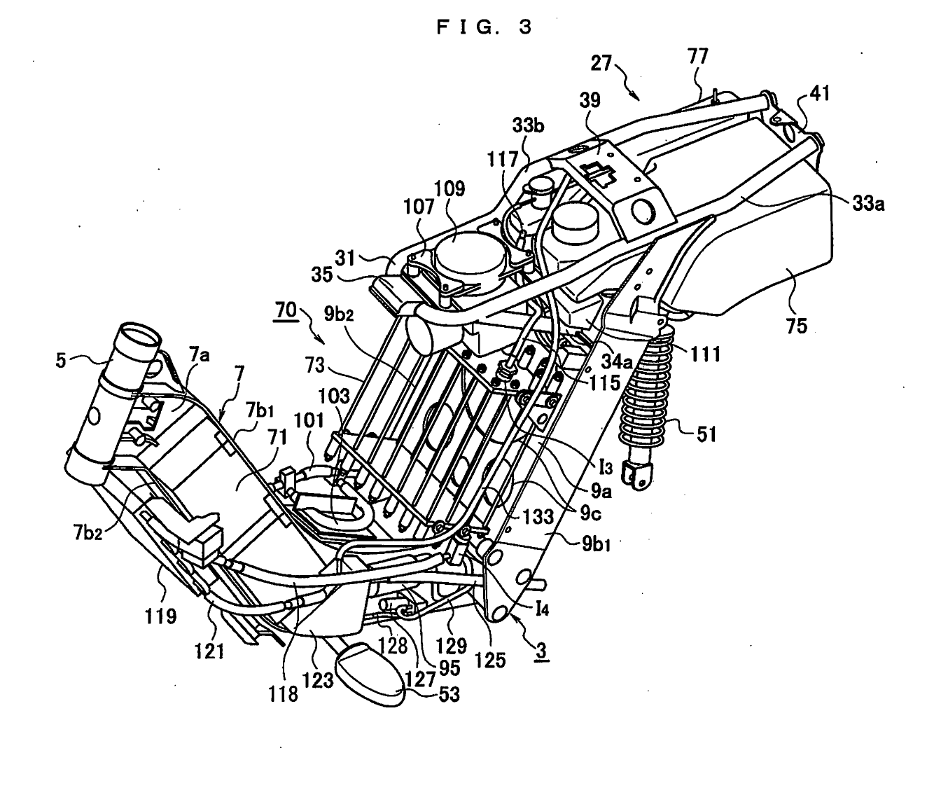

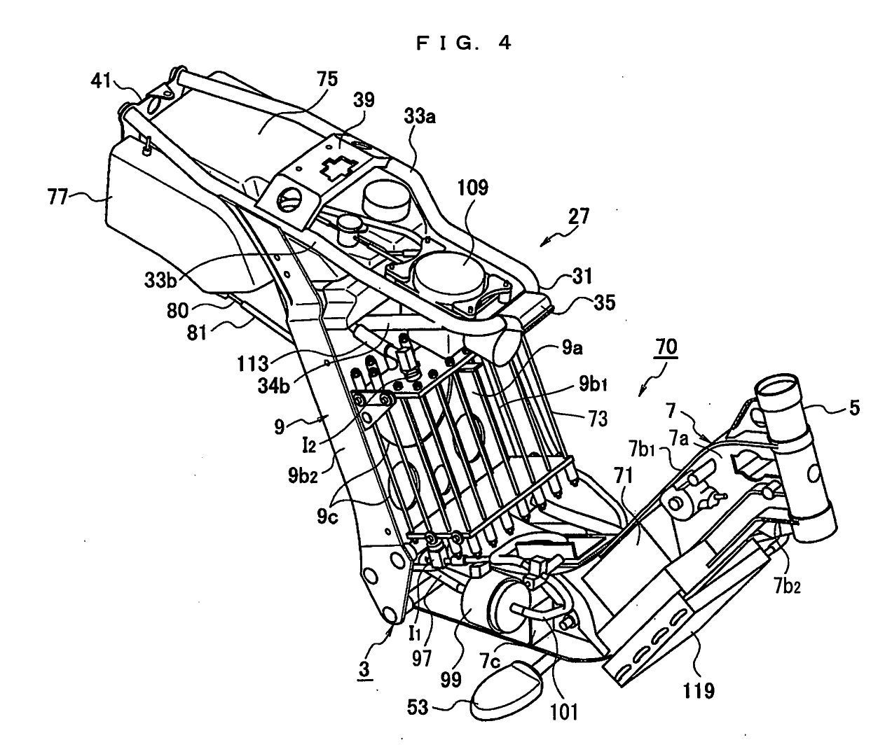

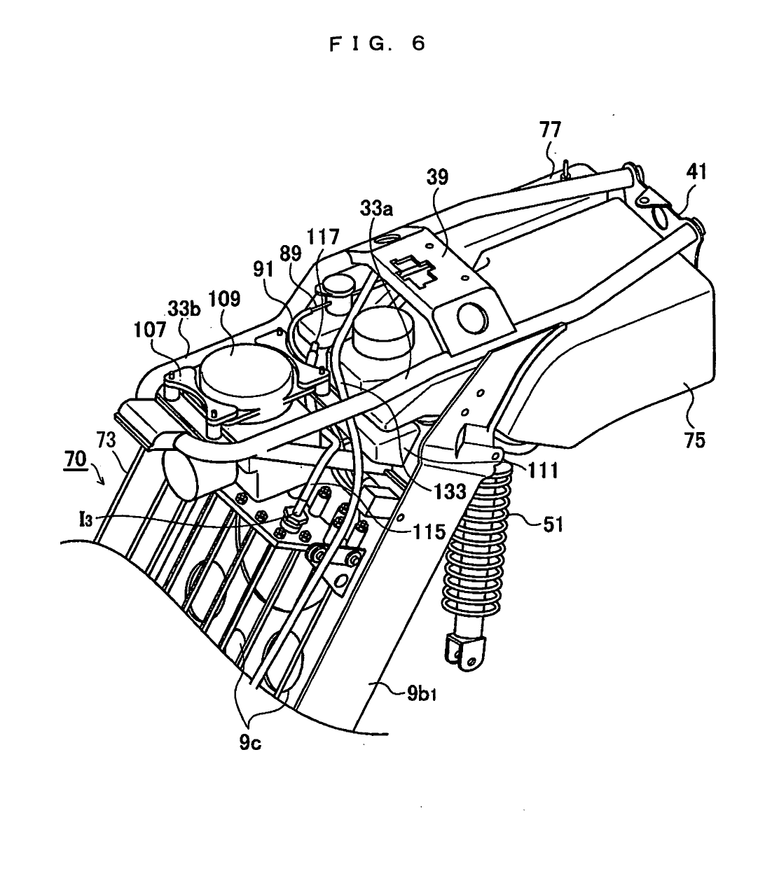

Referring to FIG. 1 through FIG. 6, the two-wheeled vehicle 1 includes a vehicle frame 3. The vehicle frame 3 includes a head pipe 5, a front frame 7 which has an I-shaped vertical section and extends in a rearward and downward direction from the head pipe 5, a rear frame 9 which has an H-shaped cross section, is connected with a rear end of the front frame 7 and rising in a rearward and upward direction, and a seat rail 27. The front frame 7 and the rear frame 9 combine to form a substantially V-shape configuration.

The front frame 7 includes a plate member 7a which extends in an axial direction of the vehicle and substantially perpendicularly to the width of the vehicle, flanges 7b1, 7b2 which extend widthwise along a top surface and a bottom surface of the plate member 7a, respectively, and reinforcing ribs 7c protruding from both surfaces of the plate member 7a. The reinforcing ribs 7c and the flanges 7b1, 7b2 provide compartments on both surfaces of the plate member 7a, which define storage walls for components of a fuel cell system to be described later.

The rear frame 9 includes a plate member 9a which extends diagonally with respect to the vehicle axis in a rearward direction, facing an upper surface of the flange 7b1 of the front frame 7, and flanges 9b1, 9b2 which extend axially of the vehicle on the left and the right sides of the plate member 9a respectively.

The plate member 9a of the rear frame 9 includes a plurality of air holes 9c for ventilation/cooling of an aqueous solution tank 77 to be described later.

A steering shaft (not shown) is pivotably mounted in the head pipe 5 for steering the vehicle. A handle support 11 is provided at an upper end of the steering shaft to which a handle 11a is fixed. Grips 13 are provided at two ends of the handle 11a. The right-hand grip 13 is preferably a rotatable throttle grip.

A pair of left and right front forks 15 extend downwardly from a bottom end of the head pipe 5. Each of the front forks 15 includes a bottom end supporting a front wheel 17 via a front wheel shaft 19. The front wheel 17 is suspended by the front forks 15, and is freely rotatable around the front wheel shaft 19.

A display/operation board 21 (hereinafter simply called a meter) is provided in front of the handle 11a of the handle support 11. The meter 21 defines an integrated dashboard including a display, such as a liquid crystal display, for providing the rider with a variety of information concerning the ride, and input devices via which the rider inputs a variety of information. A head lamp 23 is provided below the meter 21 at the handle support 11, and a flasher lamp 25 is provided on each of the left and right sides of the head lamp 23.

The seat rail 27 preferably is attached to a rear end of the rear frame 9, is made of pipe members, and has a substantially U-shaped configuration.

The seat rail 27 includes a curved pipe 31 having a substantially C-shaped configuration, a pair of left and right seat supporting pipes 33a, 33b extending from ends of the curved pipe 31, and branch pipes 34a, 34b branching from the seat supporting pipes 33a, 33b and extending diagonally in a rear downward direction.

The seat supporting pipes 33a, 33b of the seat rail 27 have their mutually opposing intermediate regions that are fixed to upper ends of the flanges 9bl, 9b2 of the rear frame 9 by welding, for example. Further, the rear ends of the branch pipes 34a, 34b are fixed by welding for example, to the plate member 9a of the rear frame 9. The seat rail 27 extends substantially horizontal along the vehicle axis.

The curved pipe 31 of the seat rail 27 supports a seat stay 35 extending therefrom, to which a seat 37 is attached and covers the curved pipe 31 of the seat rail 27 and a portion of the seat supporting pipes 33a, 33b over the regions where the seat supporting pipes 33a, 33b are fixed to the frame. The seat 37 is pivotable (to open and close) via the seat stay 35, towards and away from the seat rail 27.

An engagement bracket 39 bridges the seat supporting pipes 33a, 33b of the seat rail 27, at a location ahead of the seat rail weldment where the seat rails are opposed to each other and locks the seat 37 in a closed position.

A mounting bracket 41 is fixed to rear ends of the seat supporting pipes 33a, 33b of the seat rail 27. The mounting bracket 41 supports a tail lamp 43 and a pair of left and right flash lamps 44.

The rear frame 9 includes a lower end which pivotably supports rear arms 45 via a pivot shaft 47. The rear arms 45 have rear ends 45a which rotatably support a driving wheel or a rear wheel 49 on a shaft. The rear arm 45 and the rear wheel 49 are suspended with shock absorption with respect to the rear frame 9 by a rear shock absorber 51.

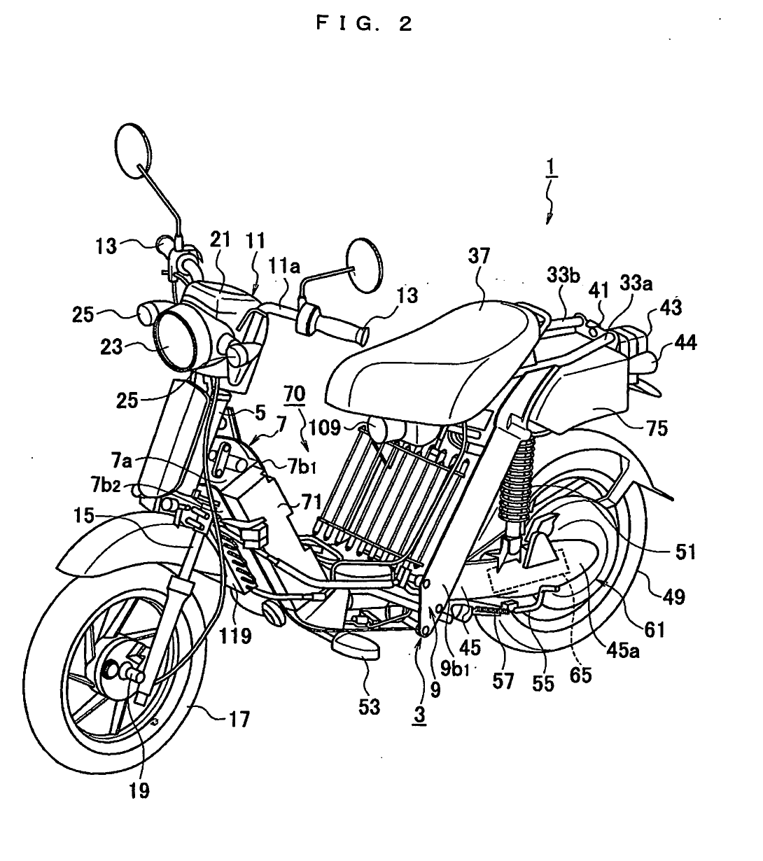

A pair of left and right foot steps 53 are provided at a lower rear portion of the front frame 7 (FIG. 1 and FIG. 2 show only one of the two foot steps 53). In addition, behind the foot steps 53, a kick stand 55 is pivotably supported by the rear arm 45. The kick stand 55 is biased in a closing direction by a return spring 57.

At a rear end 45a of the rear arm 45, an electric motor 61 of an axial gap type, for example, is provided and connected with the rear wheel 49 to rotate the rear wheel 49. A drive unit 65 which is electrically connected with the electric motor 61 and includes a controller 63 for controlling the rotating drive of the electric motor 61 is also provided at the rear end 45a of the rear arm 45.

In addition, the two-wheeled vehicle 1 according to the present preferred embodiment includes a fuel cell system 70 mounted on the vehicle frame 3 (the front frame 7 and the rear frame 9) along the seat rail 27, and a secondary battery 71 stored in the storage space enclosed by the ribs 7c on both surfaces of the plate member 7a of the front frame 7. The fuel cell system 70 generates electric energy for driving the electric motor 61 and for operating necessary electric components. The secondary battery 71 stores the electric energy generated by the fuel cell system 70, and supplies the stored electric energy to the electric components under the control of the controller 63. For example, the secondary battery 71 supplies electric energy to the drive unit 65, thereby driving the electric motor 61 to turn the rear wheel 49 and move the two-wheeled vehicle 1.

Hereinafter, the fuel cell system 70 will be described.

The fuel cell system 70 according to the present preferred embodiment is a direct methanol fuel cell system which uses methanol (an aqueous solution of methanol) directly without reformation for power generation.

The fuel cell system 70 includes a fuel-cell cell-stack 73 (hereinafter simply called a cell stack) mounted along a forward surface of the plate member 9a of the rear frame 9.

The cell stack 73 is a stack of a plurality of single battery cells, each of which is capable of generating electric energy through electrochemical reactions between hydrogen derived from methanol, and oxygen. Each single battery cell of the cell stack 73 includes an electrolyte (electrolyte film) provided by, e.g. a solid molecular film, and a pair of a fuel electrode (anode) and an air electrode (cathode) facing each other with the electrolyte in between. It should be noted here that single battery cells are not illustrated in FIG. 2 through FIG. 6.

Behind and above the cell stack 73 are a fuel tank 75 and an aqueous solution tank 77. The fuel tank 75 and the aqueous solution tank 77 are mounted on the lower portion of the supporting frames 33a, 33b via, e.g. a mounting bracket 41 on the seat rail 27. The fuel tank 75 and the aqueous solution tank 77 are preferably formed by PE (polyethylene) blow molding, for example.

The fuel tank 75 contains a methanol fuel (high concentration aqueous solution of methanol) having a high concentration level (approximately 50%, for example) which is used as a fuel for the above-mentioned electrochemical reaction in the cell stack 73.

The aqueous solution tank 77 contains an aqueous solution of the methanol, which is a solution of the methanol fuel from the fuel tank 75 diluted to a suitable concentration (approximately 3%, for example) for the electrochemical reaction in the cell stack 73.

The fuel tank 75 and the aqueous solution tank 77 are integrated with each other so as to be disposed at substantially the same height (such that the two tanks have their bottom surfaces at substantially the same height, for example), and mounted on the seat rail 27.

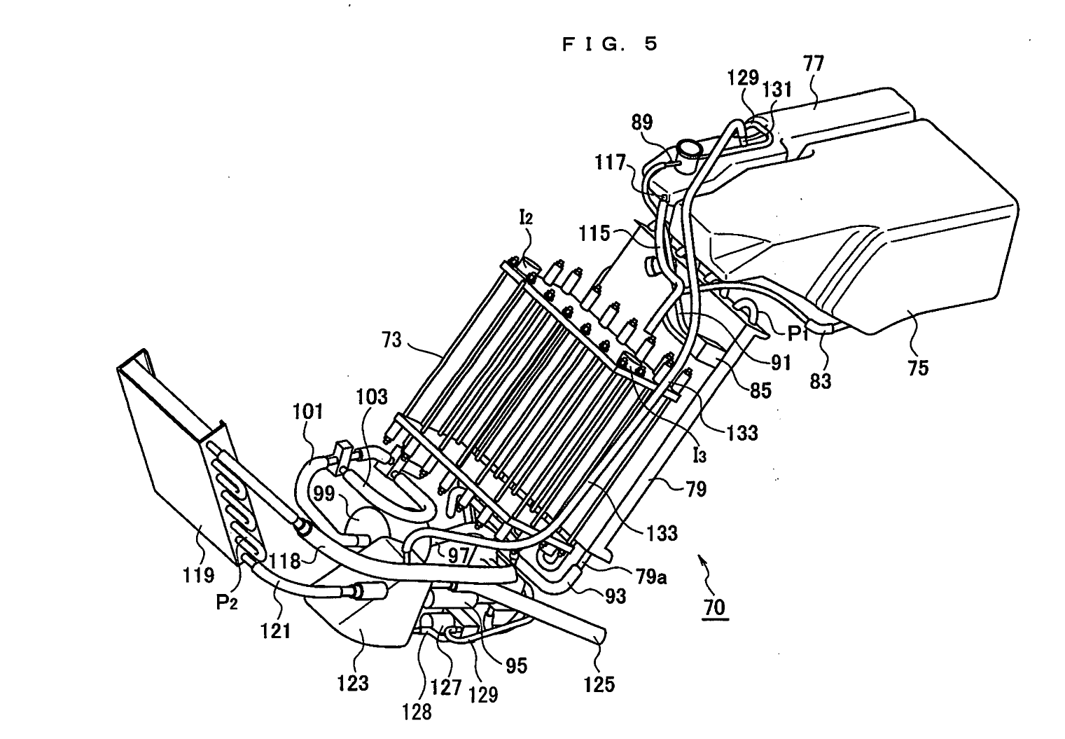

As shown in FIG. 5, a heat exchanger 79 is disposed behind the plate member 9a in the rear frame 9. The heat exchanger 79 is arranged along the cell stack 73, with the plate member 9a sandwiched therebetween. The heat exchanger 79 includes a heat exchange pipe P1 having an inlet connected with a methanol aqueous solution outlet 80 on, e.g. a bottom portion of the aqueous solution tank 77, via a connecting pipe (connection piping) 81.

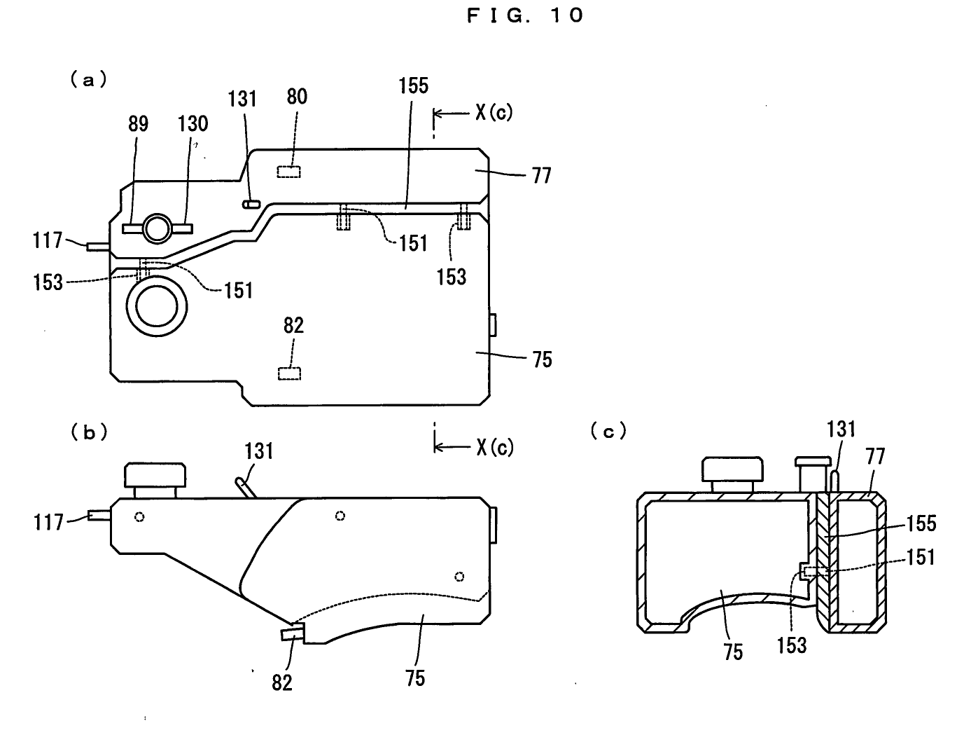

The fuel tank 75 has a lower portion provided with a high concentration methanol aqueous solution outlet 82 (See FIG. 10), with which a fuel pump 85 is connected via a connecting pipe 83. The fuel pump 85 is attached, for example, to the heat exchanger 79. The outlet of the fuel pump 85 is connected with a methanol fuel inlet 89 of the aqueous solution tank 77, via a connecting pipe 91. In the present preferred embodiment, the fuel pump 85 and the connecting pipes 83, 91 define a fuel supplier.

Further, the heat exchange pipe P1 of the heat exchanger 79 includes an outlet 79a which is connected with an aqueous solution pump 95 via a connecting pipe 93. The aqueous solution pump 95 is disposed below the cell stack 73, and is enclosed in a predetermined storage space enclosed by the rib 7c and other members on the left side surface of the plate member 7a of the front frame 7.

The aqueous solution pump 95 includes an output end connected with a filter 99 via a connecting pipe 97. The filter 99 is disposed in a predetermined storage space enclosed by the rib 7c and other members on the right side surface of the plate member 7a of the front frame 7, and removes impurities contained in the methanol aqueous solution flowing through the connecting pipe 97.

The outlet of the filter 99 is connected with a connecting pipe 101. The connecting pipe 101 is connected with a fuel inlet I1 which is disposed at the bottom of the cell stack 73, for example, for supplying the fuel (methanol aqueous solution).

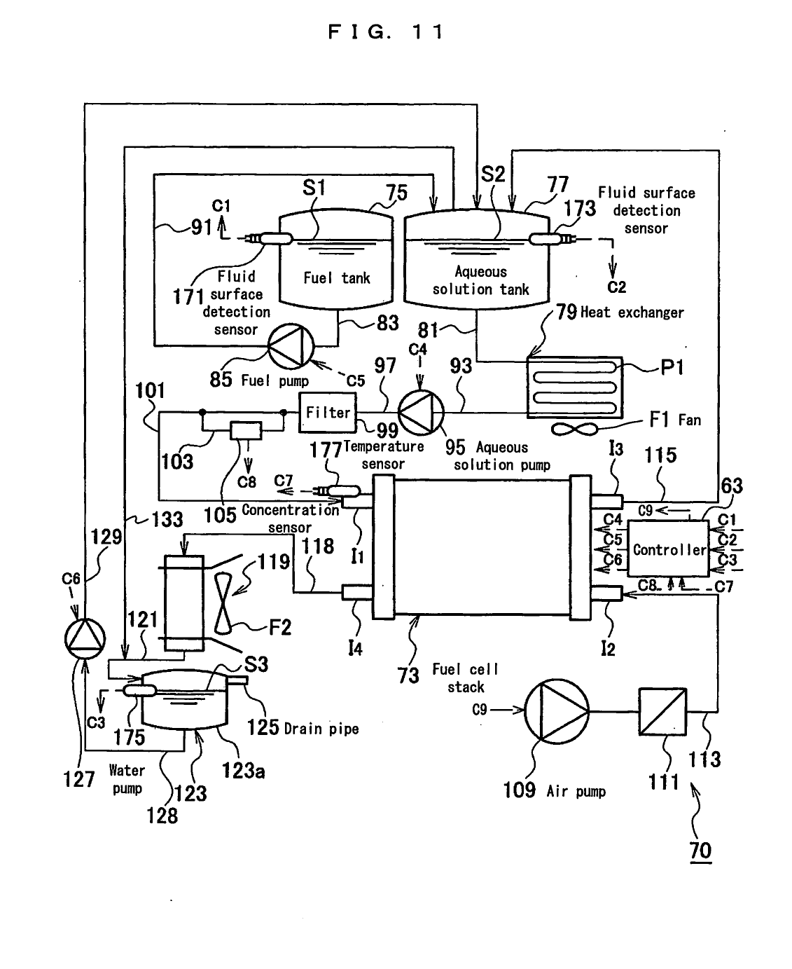

At a predetermined location in the connecting pipe 101 between the filter 99 and the cell stack 73, a branch pipe 103 is provided which branches from the connecting pipe 101. The branch pipe 103 is provided with a concentration sensor 105 (See FIG. 11) defining a concentration detector which detects the concentration of the methanol aqueous solution flowing through the connecting pipe 101 ultrasonically, for example, and transmits to the controller 63 a concentration signal (indicated by an alpha-numerical code c8 in FIG. 11) that represents the detected level of concentration. In the present preferred embodiment, the aqueous solution pump 95 and the connecting pipes 81, 93, 97 and 101 are included in an aqueous solution supplier.

The curved pipe 31 in the seat rail 27 is provided with a support bracket 107 protruding therefrom, which supports an air pump 109 that is disposed between the seat supporting pipes 33a, 33b and between the branch pipes 34a, 34b of the seat rail 27. The air pump 109 is disposed above the cell stack 73 and in front of the fuel tank 75 and the aqueous solution tank 77.

Behind the air pump 109 and disposed between the seat supporting pipes 33a, 33b and the branch pipes 34a, 34b, is a chamber 111 for removing turbulence from supplied air. The chamber 111 is connected with an output side of the air pump 109. The chamber 111 is connected to an air intake I2 at, for example, an upper region of the cell stack 73 via a connecting pipe 113. In the present preferred embodiment, the air pump 109 and the connecting pipe 113 define an air supplier.

The cell stack 73 is provided with a carbon dioxide discharge port I3 for discharging carbon dioxide (including unused methanol and water vapor) at a diagonal location with respect to the fuel inlet I1. The carbon dioxide discharge port I3 is connected with a carbon dioxide (unused methanol) inlet 117 of the aqueous solution tank 77 via a connecting pipe 115.

The cell stack 73 is provided with an air (water vapor) outlet I4 at a diagonal location with respect to the air inlet I2. The air outlet I4 is connected with an inlet end of the heat exchange pipe P2 of a gas/liquid separator 119 for providing cooling via a connecting pipe 118. The gas/liquid separator 119 is mounted along a forward surface of the flange 7b2 in the front frame 7.

Further, the outlet end of the heat exchange pipe P2 of the gas/liquid separator 119 is connected with a water tank 123 via a connecting pipe 121. The water tank 123 is disposed in a predetermined storage space below the cell stack 73 on the left side surface of the plate member 7a in the front frame 7.

The water tank 123 includes a tank main body 123a which receives gas (exhaust gas), and a drain pipe (drain piping) 125 for discharging the gas is disposed at an upper portion of the tank main body 123a.

Further, below the cell stack 73 and on the left side surface of the plate member 7a in the front frame 7, there is disposed a water pump 127. The water pump 127 is connected with a connecting pipe 128 which is connected with a bottom of the tank main body 123a. The output end of the water pump 127 is connected with a water inlet 130 (See FIG. 10) of the aqueous solution tank 77 via a connecting pipe 129. In the present preferred embodiment, the water pump 127 and the connecting pipes 128, 129 define a water supplier.

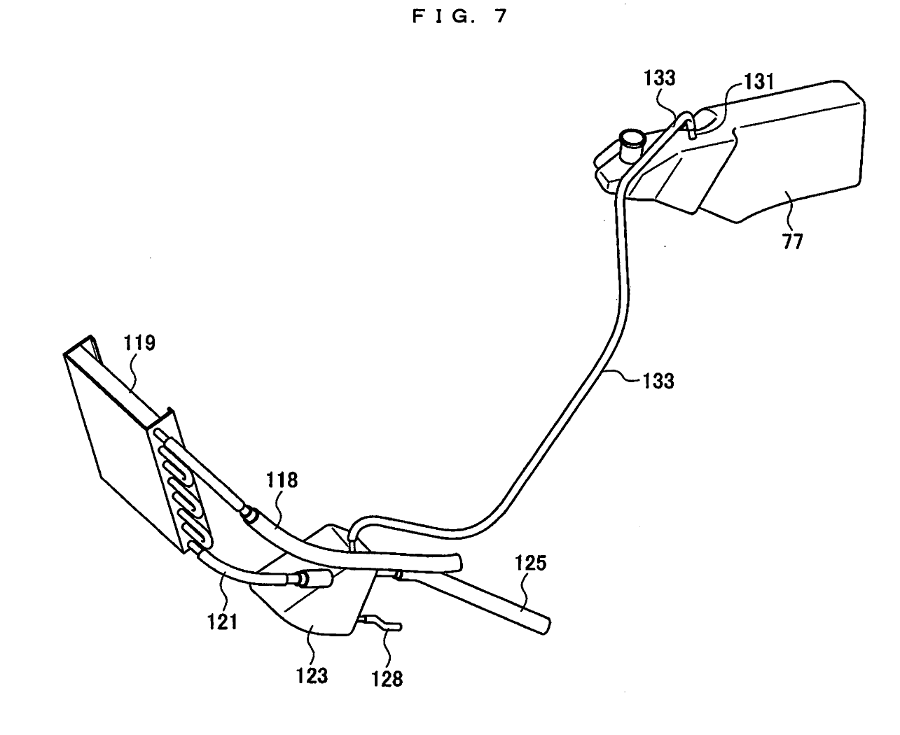

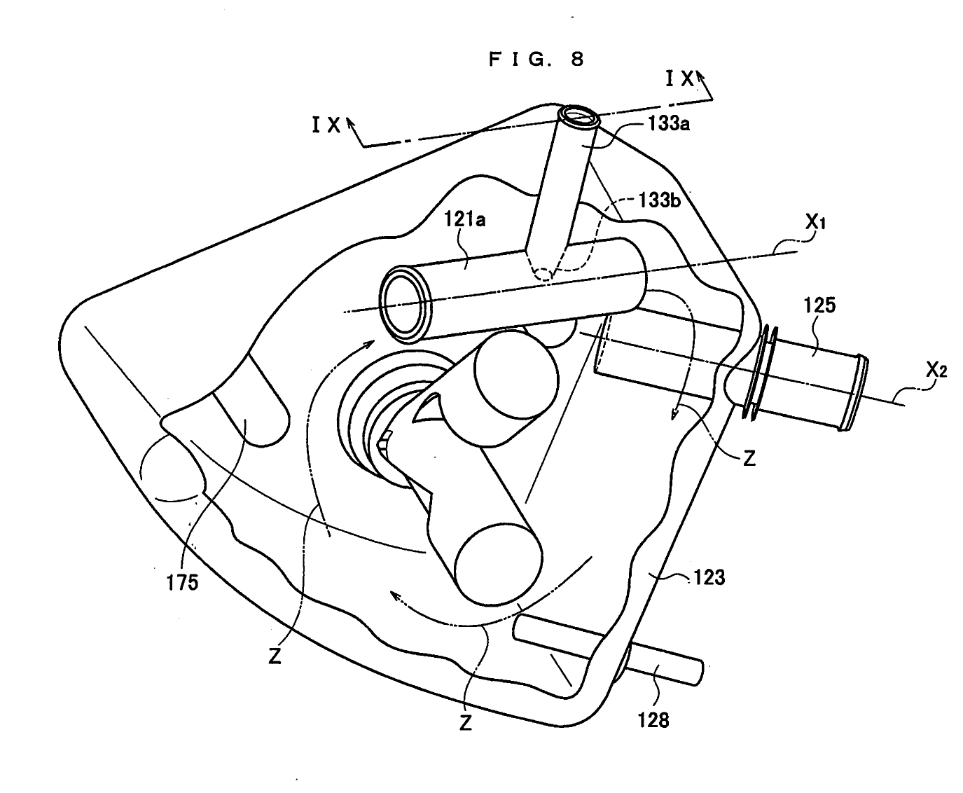

As clearly understood from FIG. 7 and FIG. 8, the aqueous solution tank 77 includes an upper region provided with a carbon dioxide outlet 131. The carbon dioxide outlet 131 is connected with an end of a connecting pipe 133. The connecting pipe 133 introduces to the water tank 123 carbon dioxide which is discharged from the carbon dioxide discharge port I3 of the cell stack 73, via the connecting pipe 115 and the carbon dioxide inlet 117, to the aqueous solution tank 77. The other end of the connecting pipe 133 is connected to an intermediate portion of the connecting pipe 121 which connects the gas/liquid separator 119 and the water tank 123.

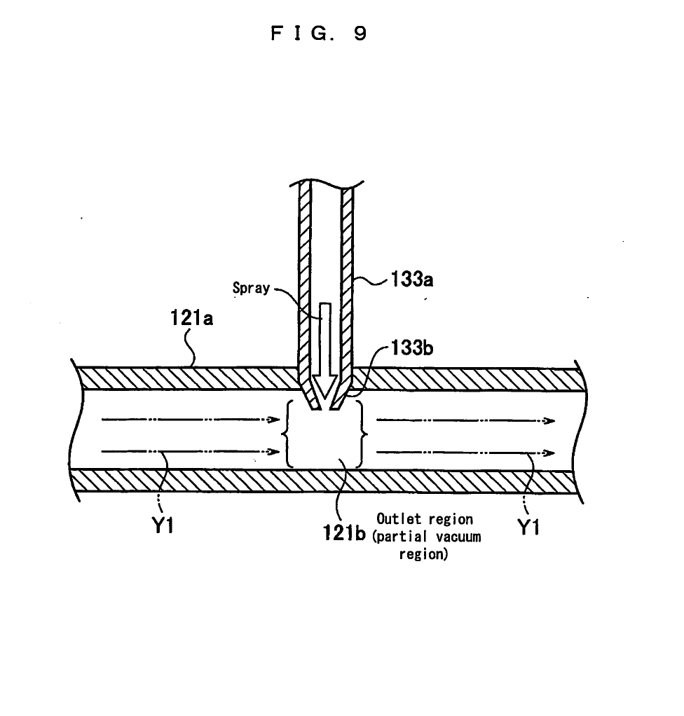

Specifically, as shown in FIG. 9, a lower end 133a of the connecting pipe 133 is connected with a water-tank-facing end 121a substantially perpendicularly to an axis of the water-tank-facing end 121a of the connecting pipe 121. In this arrangement, a penetrating end 133b of the connecting pipe 133, which extends into the connecting pipe 121, is tapered into the connecting pipe 121.

As shown in FIG. 8, the connecting pipe 121 extends inside the water tank 123. The pipe axis X1 does not extend parallel to a pipe axis X2 of the drain pipe 125 which extends inside the water tank 123.

As shown in FIG. 10(a) through FIG. 10(c), the fuel tank 75 and the aqueous solution tank 77 are preferably integrated with each other. The fuel tank 75 is a hollow body having a substantially box-like shape in a plan view and in a side view. The aqueous solution tank 77 is a hollow body, having a shape defined by the remainder of a substantially parallelepiped body without the fuel tank 75.

Mutually opposed surfaces of the fuel tank 75 and the aqueous solution tank 77 mate with each other. One of the opposed surfaces (for example, the opposed surface in the aqueous solution tank 77) is provided with a plurality of fitting studs 151 protruding therefrom toward the other of the opposed surfaces (for example, the opposed surface in the fuel tank 75).

In the above-described arrangement, the opposed surface in the fuel tank 75 is provided with a plurality of (e.g., three) fitting recesses 153 at locations corresponding to the fitting studs 151, each to be engaged with one of the fitting studs 151. As the fitting studs 151 are engaged with the recesses 153, the aqueous solution tank 77 is disposed in close proximity to the fuel tank 75, with a predetermined distance (gap) between the opposed surfaces.

In the above-described arrangement, the gap between the fuel tank 75 and the aqueous solution tank 77 is filled with a heat insulation member 155.

As shown in FIG. 11, the fuel tank 75 is provided with a fluid surface detection sensor 171 defining a fuel data detector. The fluid surface detection sensor 171 detects the fluid surface height of methanol fuel S1 in the fuel tank 75, and turns ON to transmit a sensor signal (indicated by an alpha-numerical code c1 in FIG. 11) to the controller 63 when the detected height has reached a predetermined lower limit (when the fluid volume has reached a lower limit).

The aqueous solution tank 77 is provided with a fluid surface detection sensor 173 defining an aqueous solution data detector. The fluid surface detection sensor 173 detects the fluid surface height of methanol aqueous solution S2 in the aqueous solution tank 77, and transmits a sensor signal (indicated by an alpha-numerical code c2 in FIG. 11) to the controller 63. The signal assumes an OFF state when the detected height has reached a predetermined higher limit (when the fluid volume has reached a higher limit) and an ON state otherwise.

The water tank 123 is provided with a fluid surface detection sensor 175 defining a water data detector. The fluid surface detection sensor 175 detects the fluid surface height of water S3 in the water tank 123, and turns ON to transmit a sensor signal (indicated by an alpha-numerical code c3 in FIG. 11) to the controller 63 when the detected height has reached a predetermined lower limit (when the fluid volume has reached a lower limit).

In the present preferred embodiment, the “fluid surface height” represents “data regarding an amount stored”.

A temperature sensor 177 is provided in the cell stack 73 near the fuel inlet I1. The temperature sensor 177 detects temperatures of methanol aqueous solution supplied via the fuel inlet I1, and transmits a temperature detection signal (indicated by an alpha-numerical code c7 in FIG. 11) to the controller 63.

The controller 63 of the fuel cell system 70 in the present preferred embodiment provides control of the operation of at least one of the fuel pump 85, the aqueous solution pump 95, the air pump 109 and the water pump 127 as necessary based on the detection signals sent from the above sensors 105, 171, 173 and 175. The fuel pump 85, the aqueous solution pump 95, the air pump 109 and the water pump 127 are respectively controlled by corresponding control signals c5, c4, c9 and c6 from the controller 63.

Returning to FIG. 1, the handle support 11 of the two-wheeled vehicle 1 is covered by a handle cover 181. A region behind the head pipe 5 in the vehicle frame 3, i.e. the front frame 7 and the rear frame 9 as well as a lower region of the seat 37 (including each component of the fuel cell system 70), is covered by a seat cover 183. Further, a region behind the rear frame 9 (including the fuel tank 75 and the aqueous solution tank 77 in the fuel cell system 70) is covered by an upper cover 185 which extends in a rearward direction from the seat cover 183. A region behind the head pipe 5 (including the gas/liquid separator 119 of the fuel cell system 70) is covered by a leg shield 187 which protects the rider's legs.

Next, an overall operation of the present preferred embodiment will be described, with a focus on a power generating operation in the fuel cell system 70.

Methanol aqueous solution, which has a concentration of approximately 3%, is pumped from the aqueous solution tank 77 by the aqueous solution pump 95, flows through the connecting pipe 81 and into the heat exchanger 79. While passing through the heat exchange pipes P1, the solution is cooled by a fan F1 to a temperature suitable for the cell stack 73 (for example, approximately 40° C.).

The methanol aqueous solution which has been cooled flows through the connecting pipes 93 and 97, and into the filter 99, where impurities are removed. Then, the solution flows through the connecting pipe 101 and the fuel inlet I1, and is supplied directly to the anode side of the cell stack 73.

On the other hand, air is pumped by the air pump 109, sent to the chamber 111 for decreased turbulence, and then supplied to the cathode side via the connecting pipe 113 and the air inlet I2 of the cell stack 73.

During this step, on the anode side at each battery cell of the cell stack 73, methanol and water in the supplied methanol aqueous solution chemically react with each other to produce carbon dioxide and hydrogen ions. The hydrogen ions flow to the cathode side via the electrolyte, and electrochemically react with oxygen in the air supplied to the cathode, to produce water and electric energy.

The generated electric energy is sent to the secondary battery 71 for storage, and is used for driving the two-wheeled vehicle 1 and for operating related components.

At each battery cell, the electrochemical reaction at the anode produces exhaust gas (primarily carbon dioxide), which is heated (for example, up to approximately 65° C.-70° C.) by heat generated in the electrochemical reaction. The exhaust gas contains the high temperature methanol which was not used at the anode.

The exhaust gas (carbon dioxide) which contains unused methanol is returned to the aqueous solution tank 77 via the carbon dioxide discharge port I3 of the cell stack 73 and the connecting pipe 115.

After being returned to the aqueous solution tank 77, the exhaust gas (carbon dioxide) containing unused methanol flows out of the aqueous solution tank 77 via the carbon dioxide outlet 131 located at an upper region of the aqueous solution tank 77 and flows through the connecting pipe 133.

The connecting pipe 133 extends a long distance from the aqueous solution tank 77 above the rear frame 9 to the connecting pipe 121 in the front frame 7. Therefore, the exhaust gas (carbon dioxide) which contains unused methanol is cooled sufficiently in the connecting pipe 133 to, for example, approximately 40° C., and flows toward the water-tank-facing end 121a of the connecting pipe 121 which is the connecting pipe which connects the gas/liquid separator 119 and the water tank 123.

Water vapor generated at the cathode flows through the air (water vapor) outlet port I4 and the connecting pipe 118, and through the heat exchange pipe P2 of the gas/liquid separator 119, during which cooling (temperature decrease) is provided by a fan F2, for separation into gas and liquid.

The gas (water vapor) thus separated flows through the connecting pipe 121 (See arrow Y1 in FIG. 9) at a high velocity (for example, at approximately 140 liters per minute), and flows into the water tank 123 via the water-tank facing end 121a.

As described above, the exhaust gas (carbon dioxide) containing unused methanol is sent to the water-tank-facing end 121a of the connecting pipe 121, via the connecting pipe 133.

During this process, if the pressure in the aqueous solution tank 77 is less than the pressure in the water tank 123, then it is not possible to return the exhaust gas (carbon dioxide) containing unused methanol to the water tank 123, and thus, it is not possible to recover the unused methanol.

One idea may be to keep the pressure in the aqueous solution tank 77 greater than the pressure in the water tank 123. In this case, however, the higher pressure will increase the amount of carbon dioxide dissolved in the aqueous solution tank 77, as well as the load on the fuel pump 85 which sends methanol fuel to the aqueous solution tank 77, and the loads on the water pump 127 which returns water to the aqueous solution tank 77. These may result in reduced energy efficiency.

In the present preferred embodiment, as shown in FIG. 8 and FIG. 9, the tip 133b of the connecting pipe 133 drives into the connecting pipe 121. Thus, in the connecting pipe 121, an outlet region 121b around the connecting pipe lower end 133a has a decreased pipe diameter. As a result, gas which is flowing in the connecting pipe 121, has an increased flow velocity at the outlet region 121b, and under the Bernoulli's principle, the pressure at the outlet region 121b becomes less than regions adjacent thereto (i.e., a negative pressure is generated in the outlet region 121b). As a result, carbon dioxide which flows into the connecting pipe lower end 133a is sucked into the connecting pipe 121 under the atomizer principle, and flows into the water tank 123 with other gases which are flowing in the connecting pipe 121 at a high velocity.

Meanwhile, in the water tank 123 in the present preferred embodiment, the pipe axis X1 of the connecting pipe 121 is not parallel to the pipe axis X2 of the drain pipe 125 which is connected inside the water tank 123, as shown in FIG. 8. Because of this, most of the gas flowing into the water tank 123 hits the walls in the water tank 123 and circulates in the tank as indicated by arrows Z in the figure, while liquid, i.e. aqueous solution of unused methanol, drips efficiently in the water tank 123, and is gradually discharged from the drain pipe 125.

As a result, according to the present preferred embodiment, unused methanol contained in carbon dioxide which is generated by the electrochemical reaction in the cell stack 73, at the water tank 123 is easily and efficiently recovered without decreasing overall energy efficiency.

While the fuel cell system 70 is generating electricity, the controller 63 controls the operation of the fuel pump 85, the aqueous solution pump 95 and the water pump 127, based on a concentration signal c8 which is a detection signal indicating the concentration of the methanol aqueous solution from the concentration sensor 105, a sensor signal c1 which is a detection signal indicating the fluid height S1 from the fluid surface detection sensor 171, a sensor signal c2 which is a detection signal indicating the fluid height S2 from the fluid surface detection sensor 173, a sensor signal c3 which is a detection signal indicating the fluid height S3 from the fluid surface detection sensor 175, a temperature detection signal c7 which is a detection signal from the temperature sensor 177 indicating the temperature of the methanol aqueous solution for direct transmission to the cell stack 73, as well as other information.

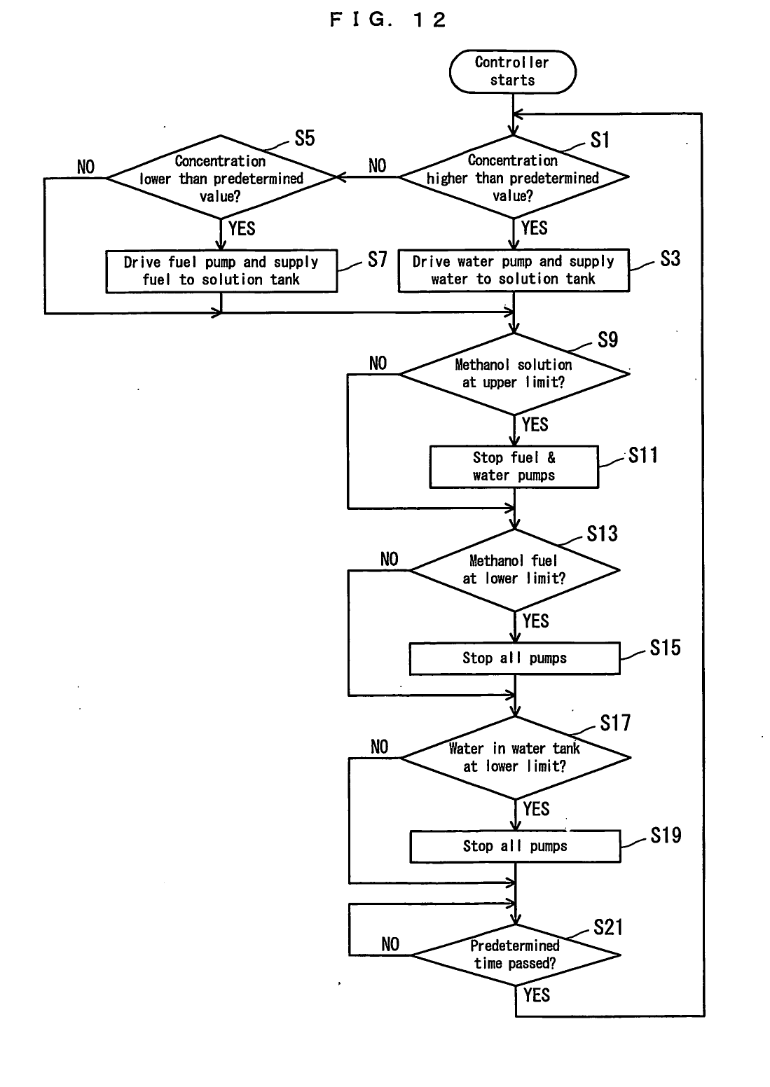

Referring to FIG. 12, an operation example of the fuel cell system 70 will be described.

First, the controller 63 checks whether the concentration of the methanol aqueous solution in the aqueous solution tank 77 is greater than a predetermined level (e.g., approximately 3%) that is appropriate for the electrochemical reactions, based on a concentration signal indicating the concentration from the concentration sensor 105 (Step S1).

If the concentration of the methanol aqueous solution is greater than the predetermined value (approximately 3%), the fuel pump 85 is stopped, and the water pump 127 is driven to supply water from the water tank 123 to the aqueous solution tank 77 (Step S3). In other words, the supply operation by the fuel supplier is stopped and a supply operation of the water supplier is performed. In this manner, the concentration of the methanol aqueous solution in the aqueous solution tank 77 is decreased toward the predetermined target value.

On the other hand, if the concentration of the methanol aqueous solution in the aqueous solution tank 77 is less than the predetermined value (approximately 3%) (if Step S1 gives NO, Step S5 gives YES), the water pump 127 is stopped, and the fuel pump 85 is driven to supply methanol fuel from the fuel tank 75 to the aqueous solution tank 77 (Step S7). In this manner, the concentration of the methanol aqueous solution in the aqueous solution tank 77 is increased toward the predetermined target value.

This concentration control reduces so-called crossover in which unused methanol contained in the methanol aqueous solution in the cell stack 73 moves on the cathode side through the electrolyte. This improves electric energy generation efficiency, and reduces failures and other problems in the cell stack 73 caused by increased heat in the cell stack 73.

While the controller 63 is conducting the above-described concentration control, a check in step S9 is performed. The check in step S9 is also performed when the methanol aqueous solution in the aqueous solution tank 77 already has the predetermined concentration (if Step S5 gives NO). In step S9, the controller 63 checks whether the sensor signal c2 which relates to the height of fluid surface S2 in the aqueous solution tank 77 indicates an OFF state, i.e. if the amount of methanol aqueous solution stored in the aqueous solution tank 77 has reached an upper limit (Step S9).

If the amount of methanol aqueous solution stored in the aqueous solution tank 77 has reached the upper limit, the controller 63 stops the fuel pump 85 and the water pump 127 (Step S11). This maintains the amount of methanol aqueous solution at an appropriate level in the aqueous solution tank 77. On the other hand, if the amount of methanol aqueous solution stored in the aqueous solution tank 77 has not reached the upper limit, the fuel pump 85 or the water pump 127 continues to supply fuel or water.

Next, the controller 63 checks whether the sensor signal c1 which relates to the height of fluid surface S1 in the fuel tank 75 indicates an ON state, i.e. if the amount of methanol fuel in the fuel tank 75 has reached a lower limit (Step S13).

If the amount of the methanol fuel in the fuel tank 75 has reached the lower limit, all of the pumps 85, 95, 109 and 127 are stopped to discontinue operation of the entire fuel cell system 70 (Step S15). Specifically, the supply operations of the fuel supplier, the aqueous solution supplier, the water supplier and the air supplier are stopped. As a result, malfunctions in the fuel cell system 70 are prevented, the concentration of the methanol aqueous solution is prevented from becoming excessively low, and damage to the solid electrolyte film is prevented. Therefore, the present preferred embodiment maintains outstanding reliability of the entire fuel cell system 70.

On the other hand, if the amount of methanol fuel stored in the fuel tank 75 has not reached the lower limit, the operation status of each pump is not changed.

Further, the controller 63 checks whether the sensor signal c3 which indicates the height of fluid surface S3 in the water tank 123 assumes an ON status, i.e. if the amount of water stored in the water tank 123 has reached a lower limit (Step S17).

If the amount of water in the water tank 123 has reached the lower limit, all of the pumps 85, 95, 109 and 127 are stopped to discontinue operation of the entire system 70 (Step S19). In other words, if the amount of water in the water tank 123 has reached the lower limit, the supply of methanol fuel is stopped. This prevents methanol fuel from being supplied when it is impossible to supply water from the water tank 123 to the aqueous solution tank 77. Therefore, the concentration of the methanol aqueous solution does not become excessively high, an excessive temperature increase is prevented in the cell stack 73, and outstanding reliability of the entire fuel cell system 70 is achieved.

On the other hand, if the amount of water stored in the water tank 123 has not reached the lower limit, the operation status of each pump is not changed.

Then, the controller 63 waits in Step S21 until a predetermined amount of time has passed, and then the process returns to Step S1.

According to the present preferred embodiment, the concentration of methanol aqueous solution which is supplied to the cell stack 73 is controlled such that a predetermined value (for example, approximately 3%) is maintained by supplying methanol fuel or water to the aqueous solution tank 77. This reduces the crossover.

Further, in addition to control of the concentration, operation control of at least one of the pumps 85, 95, 109 and 127 is provided, based on the sensor signal c1 which relates to the height of fluid surface S1 in the fuel tank 75, the sensor signal c2 which relates to the height of fluid surface S2 in the aqueous solution tank 77, and the sensor signal c3 which relates to the height of fluid surface S3 in the water tank 123.

When at least one of these sensor signals c1-c3 indicates a problem in the fuel cell system 70, the controller 63 performs a controlling operation in accordance with the detected signal (for example, when the sensor signal c2 indicates OFF, then the fuel pump 85 and the water pump 127 are stopped, all pumps are stopped when the sensor signal c1 indicates ON, and all pumps are stopped when the sensor signal c3 indicates ON). This prevents foreseeable problems, thereby maintaining outstanding reliability of the entire fuel cell system 70.

When the fuel cell system 70 is mounted on a vehicle, such as the two-wheeled vehicle 1 as in the present preferred embodiment, the sizes of the fuel tank 75, the aqueous solution tank 77 and the water tank 123 are reduced. In this case, a fluid storage status (ratio) in each tank are prone to change. For example, the tank is filled with fluid or runs out of fluid at a higher rate than with a larger tank. Therefore, operation control on the fuel cell system 70 while monitoring on the fluid level in the tank according to the present invention is especially beneficial when using small tanks.

Further, according to the present preferred embodiment, the fuel tank 75 and the aqueous solution tank 77 are preferably integrated into a one-piece tank. As a result, the number of parts and components which must be assembled is reduced as compared to where each of the fuel tank 75 and the aqueous solution tank 77 must be assembled individually. This also facilitates assembly on the vehicle frame 3.

Further, according to the present preferred embodiment, the fuel tank 75 and the aqueous solution tank 77 are disposed close to each other with a predetermined gap therebetween, and the gap is filled with a heat insulation member 155. Therefore, the gap filled with the heat insulation member 155 reduces heat transfer from the aqueous solution tank 77 to the fuel tank 75, and enables the heat insulation member 155 to maintain the temperature of the aqueous solution tank 77.

In the present preferred embodiment, the description describes a case in which the fuel cell system 70 is mounted on a two-wheeled vehicle. The present invention is not limited to this, and application may be made to any other kinds of transportation equipment including automobiles, ships and boats.

The present invention is also applicable to a fuel cell system which includes a reformer. Further, the present invention is also applicable to a fixed-type fuel cell system.

The present preferred embodiment preferably uses a methanol fuel, and a methanol aqueous solution as the fuel aqueous solution. However, the present invention is not limited thereto. For example, an alcohol fuel such as ethanol, and an alcohol aqueous solution such as ethanol aqueous solution may be used.

Still further, in the present preferred embodiment, each of the fuel data detector, the aqueous solution data detector and the water data detector is preferably defined by a fluid surface detection sensor which detects if the amount of fluid in the corresponding tank has reached an upper or lower limit. However, the present invention is not limited thereto. Alternatively, for example, capacity sensors may be used to detect the fluid volume in the tank, for detection if the amount of fluid in the corresponding tank has reached an upper or lower limit. In this case, “the fluid volume itself” represents the “data relating to an amount stored”.

Further, the controller 63 may control pump operations based on the fluid volume in the tank.

Still further, the operation shown in FIG. 12 provides a concentration control by operating either one of the fuel pump 85 and the water pump 127 (performing an operation in step S3 or an operation in step S7). The present invention is not limited thereto. For example, concentration control may be provided by operating both of the fuel pump 85 and the water pump 127 together.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

1-9. (canceled)

10. A fuel cell system comprising:
a fuel tank for storing fuel;
an aqueous solution tank for storing a fuel aqueous solution having a concentration less than that of the fuel stored in the fuel tank;
a fuel supplier for supplying the fuel stored in the fuel tank to the aqueous solution tank;
a fuel cell stack supplied with the fuel aqueous solution from the aqueous solution tank for generating electric energy through electrochemical reactions;
a water tank for storing water to be supplied to the aqueous solution tank;
a water supplier for supplying water stored in the water tank to the aqueous solution tank;
a concentration detector for detecting a concentration of the fuel aqueous solution supplied to the fuel cell stack;
an aqueous solution detector for detecting data relating to an amount of the fuel aqueous solution stored in the aqueous solution tank; and
a controller for controlling a supply operation of at least one of the fuel supplier and the water supplier based on an output from the concentration detector, and controlling a supply operation of the fuel supplier and the water supplier based on an output from the aqueous solution detector.

11. The fuel cell system according to claim 10, wherein the controller stops the supply operation of the at least one of the fuel supplier and the water supplier upon receipt of an output from the aqueous solution detector indicating that the amount of fuel aqueous solution stored in the aqueous solution tank has reached an upper limit.

12. The fuel cell system according to claim 10, further comprising:
an aqueous solution supplier for supplying the fuel aqueous solution stored in the aqueous solution tank to the fuel cell stack; and
a fuel detector for detecting data indicating an amount of the fuel stored in the fuel tank; wherein
the controller stops a supply operation of the fuel supplier, the aqueous solution supplier and the water supplier upon receipt of an output from the fuel detector indicating that the amount of fuel stored in the fuel tank has reached a lower limit.

13. The fuel cell system according to claim 10, further comprising:
an aqueous solution supplier for supplying the fuel aqueous solution stored in the aqueous solution tank to the fuel cell stack; and
a water detector for detecting data indicating an amount of water stored in the water tank; wherein
the controller stops a supply operation of the fuel supplier, the aqueous solution supplier and the water supplier upon receipt of an output from the water detector indicating that the amount of water stored in the water tank has reached a lower limit.

14. A fuel cell system comprising:
a fuel tank for storing fuel;
an aqueous solution tank for storing a fuel aqueous solution having a concentration less than that of the fuel stored in the fuel tank;
a fuel supplier for supplying the fuel stored in the fuel tank to the aqueous solution tank;
a fuel cell stack supplied with the fuel aqueous solution from the aqueous solution tank for generating electric energy through electrochemical reactions;
a water tank for storing water to be supplied to the aqueous solution tank;
a water supplier for supplying water stored in the water tank to the aqueous solution tank;
a water detector for detecting data indicating an amount of the water stored in the water tank; and
a controller for controlling a supply operation of the fuel supplier based on an output from the water detector.

15. The fuel cell system according to claim 14, wherein the controller stops the supply operation of the fuel supplier upon receipt of an output from the water detector indicating that the amount of water stored in the water tank has reached a lower limit.

16. A fuel cell system comprising:
a fuel tank for storing fuel;
an aqueous solution tank for storing a fuel aqueous solution of a concentration lower than that of the fuel in the fuel tank;
a fuel supplier for supplying the fuel stored in the fuel tank to the aqueous solution tank;
a fuel cell stack supplied with the fuel aqueous solution from the aqueous solution tank for generating electric energy through electrochemical reactions;
a water tank for storing water to be supplied to the aqueous solution tank;
a water supplier for supplying water stored in the water tank to the aqueous solution tank;
a fuel detector for detecting data indicating an amount of the fuel stored in the fuel tank; and
a controller for controlling a supply operation of the water supplier based on an output from the fuel detector.

17. The fuel cell system according to claim 16, wherein the controller stops the supply operation of the water supplier upon receipt of an output from the fuel detector indicating that the amount of the fuel stored in the fuel tank has reached a lower limit.

18. Transporting equipment including the fuel cell system according claim 10.
